(19) United States
(12) Patent Application Publication
(10) Pub. No.: US 2014/0098336 A1
(43) Pub. Date: Apr. 10, 2014

(54) OPTICAL DETECTION METHOD OF LCD PANEL BY PHOTO-ALIGNMENT AND DETECTION DEVICE THEREOF

(71) Applicant: SHENZHEN CHINA STAR OPTOELECTRONICS TECHNOLOGY CO. LTD, Shenzhen (CN)

(72) Inventors: Shengpeng Mo, Shenzhen (CN); Wenpin Chiang, Shenzhen (CN)

(73) Assignee: SHENZHEN CHINA STAR OPTOELECTRONICS TECHNOLOGY CO., LTD, Shenzhen (CN)

(21) Appl. No.: 13/701,831

(22) PCT Filed: Oct. 25, 2012
(86) PCT No.: PCT/CN2012/083471

§ 371 Date: Dec. 4, 2012

(30) Foreign Application Priority Data
Oct. 10, 2012 (CN) 201210381241.6

(51) Int. Cl. G02F 1/13

(52) U.S. Cl. CPC G02F 1/1309
USPC 349/192

(57) ABSTRACT

An optical detection method of a photo-alignment LCD panel includes steps: A. generating a model image according to an internal image of a qualified prearranged detection unit of a photo-alignment LCD panel; B. generating an image by obtaining an internal image of the detection unit of the photo-alignment LCD panel to be inspected using a unit of the prearranged detection unit. The method further includes comparing the image with the model image and generating a comparison result according to the comparison. In the present disclosure, the prearranged detection unit is used as a reference comparison unit. The internal image of the detection unit is added into the model image.

### TECHNICAL FIELD

The present disclosure relates to the field of liquid crystal displays, and more particularly to an optical detection method of a liquid crystal display (LCD) panel by photo-alignment and a detection device thereof.

### BACKGROUND

Because a liquid crystal display (LCD) uses three-primary colors, each color corresponds to one sub-pixel of the LCD. Then, at least three sub-pixels corresponding to the primary colors form a display pixel. A liquid crystal (LC) is filled in the sub-pixels. To increase response speed of LC molecules, certain angles are generally set in advance for the LC molecules. FIG. 1 shows a process flow for setting pre-tilt angles of the LC molecules by adopting photo-alignment technology. In the photo-alignment technology, monomers in a panel react by illumination of ultraviolet rays (UV) by applying voltage to a substrate, thus achieving aligning of the LCs. Currently, photo-alignment technology of an LCD panel is widely applied to high-generation the thin film transistor (TFT) LCD industry. When the LCD panel is subject to photo-alignment, to discover unqualified products in time, an automatic optic inspection (AOI) machine is configured at a back of an ultraviolet irradiation (UVM) device to inspect whether a substrate alignment image (LC image) is abnormal. The AOI machine can intercept and inspect abnormal alignment in time, which avoids great abandonment of the LCD panel caused by poor contact between UVM device and a probe bar. To inspect abnormal alignment using the AOI machine is to inspect of the LC image. In applying voltage to the substrate, the LC image is obtained by an image pick-up device. A model image established in advance by inspection procedures is used to make a comparison marking (see FIG. 2). If the difference between the images is great, result is not good (NG). If the difference is small, result is OK. Only a single sub-pixel is used as a detection unit in the current image mode, where a frame image of the single sub-pixel is first obtained. Then, OK or NG is determined by the difference similarity between a model frame image and the frame image of the single sub-pixel. However, the determination may easily lead to errors.

### SUMMARY

In view of the above-described problems, the aim of the present disclosure is to provide an optical detection method of a liquid crystal display (LCD) panel by photo-alignment and a detection device thereof reducing image comparison misjudgments and increasing success of interception and inspection.

The aim of the present disclosure is achieved by the following technical scheme:

An optical detection method of an LCD panel by photo-alignment comprises steps:

A. generating a model image according to an internal image of a qualified prearranged detection unit of a photo-alignment LCD panel; and

B. generating an image by obtaining an internal image of the detection unit of the photo-alignment LCD panel to be inspected using a unit of the prearranged detection unit, comparing the image with the model image and generating a comparison result according to the comparison.

Furthermore, in the step A, the detection unit is one sub-pixel. The model image comprises the internal image of the sub-pixel. This is a specified division mode of the detection unit. The sub-pixels as a basic member of a pixel are compared one by one, thus increasing a success of intercepting and inspecting a single poor sub-pixel, ensuring integrity of each sub-pixel of a qualified finished product and improving display quality.

Furthermore, the model image comprises at least one sub-pixel frame image. The sub-pixel frame image is added, thus increasing comparison features and obtaining accurate judgment.

Furthermore, in the step A, the detection unit comprises at least three sub-pixels corresponding to primary colors. The model image comprises the frame images of all the sub-pixels. LCD uses pixels as a basic display unit. Each pixel comprises at least three sub-pixels. In practical production, a fault that a certain sub-pixel is not displayed at all may occur. Thus, in the technical scheme, at least one pixel as a unit is used as the detection unit which can detect a no-display fault of single sub-pixel in pixels and further increase the success of interception and inspection.

Furthermore, the model image comprises at least one sub-pixel internal image. The sub-pixel internal image is added, thus increasing the features of the internal image. The internal image is added and compared to further improve the judgment accuracy.

Furthermore, in the step B, the internal image of the detection unit to be inspected is compared with the model image using a blurred comparison method of a computer, and generating a comparison result according to the comparison. This is a specified comparison method.

Furthermore, in the step A, a qualified internal image of the detection unit of the photo-alignment LCD panel is obtained firstly by an image pick-up device. After that, line features of the internal image are extracted by the computer to form a new picture and the model image is formed. The inventor finds after study that when abnormal alignment occurs, decorative patterns of dark lines and dark lines resembling patterns of a stomach of a fish may occur in the sub-pixels. The difference from normal sub-pixels is clear. Moreover, poor patterns have obvious line features. Thus, the line patterns of the internal image of the sub-pixels are used as the model image. Only the line patterns are compared (similar to fingerprint identification) without feature comparison related to colors. Difficulty of the comparison can be simplified and speed of the comparison can be increased while ensuring a success of intercepting and inspecting abnormal alignment.

Furthermore, in the step A, clarity of an internal structure of the detection unit is maximized by regulating multiplying power of the image pick-up device and brightness of a backlight source. Then, the internal image of the qualified detection unit of the photo-alignment LCD panel is obtained as the model image. By increasing the image resolution, more reference features can be obtained, which is beneficial to increase the comparison accuracy.

An optical detection device of a photo-alignment LCD panel comprises:

an image pick-up device obtaining the internal image of the detection unit;

a modeling device coupling with the image pick-up device and obtaining the internal image of a qualified detection unit of the photo-alignment LCD panel as a model image; and

a comparison device comparing an internal image of the detection unit to be inspected with the model image.

Furthermore, the detection unit is one sub-pixel. The modeling device obtains the internal image of the sub-pixel as the model image. This is a specified division mode of the detection unit. The sub-pixels as a basic member of pixel are compared one by one, thus increasing the success of intercepting and inspecting a single poor sub-pixel, ensuring the integrity of each sub-pixel of a qualified finished product and improving the display quality.

Furthermore, the detection unit comprises at least three sub-pixels corresponding to primary colors. The modeling device obtains the frame images of all the sub-pixels as the model image. The LCD uses the pixel as a basic display unit. Each pixel comprises at least three sub-pixels. In practical production, the fault that a certain sub-pixel is not displayed at all may occur. Thus, in the technical scheme, at least one pixel as the unit is used as the detection unit which can detect the no-display fault of a single sub-pixel in pixel and further increase the success of interception and inspection.

In the present disclosure, the prearranged detection unit is used as a reference comparison unit. The internal image of the detection unit is added into the model image. Compared with a method of simply using a sub-pixel frame images as the model image, there are more comparison features and wider coverage by using the present method. In this way, more reference details are obtained in comparison, thus effectively reducing the misjudgment of image comparison and increasing the success of interception and inspection.

### BRIEF DESCRIPTION OF FIGURES

FIG. 1 is a principle diagram of a photo-alignment liquid crystal display (LCD) panel;

FIG. 2 is a schematic diagram of a detection method of using a single sub-pixel frame image as a comparison object in the prior art;

FIG. 3 is a fault diagram of a poor inner part of a sub-pixel;

FIG. 4 is a fault diagram of no display of a sub-pixel; and

FIG. 5 is a flow diagram of a method of the present disclosure.

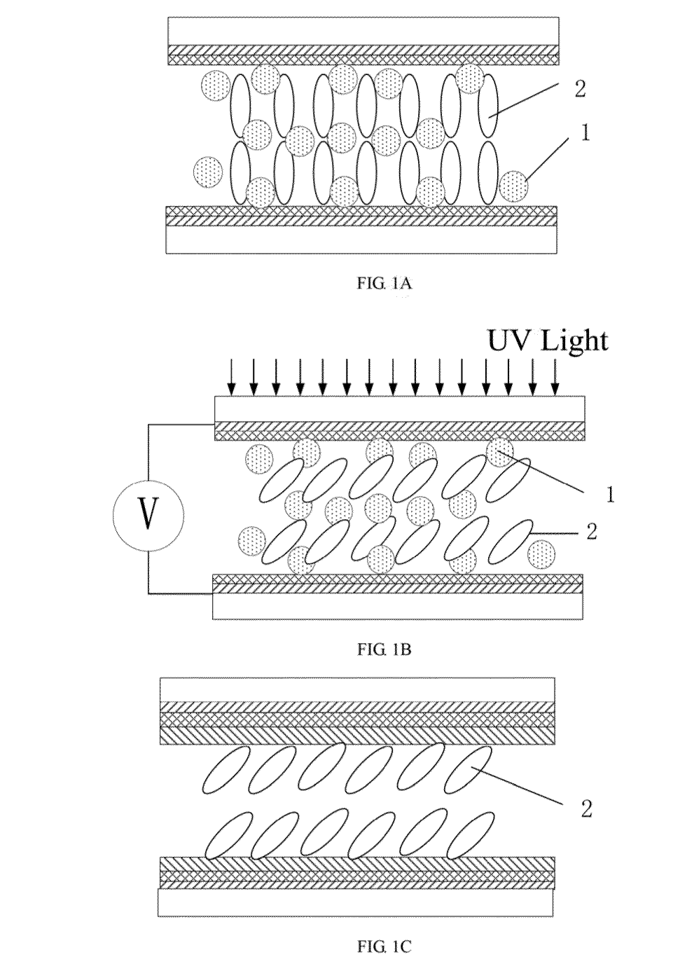

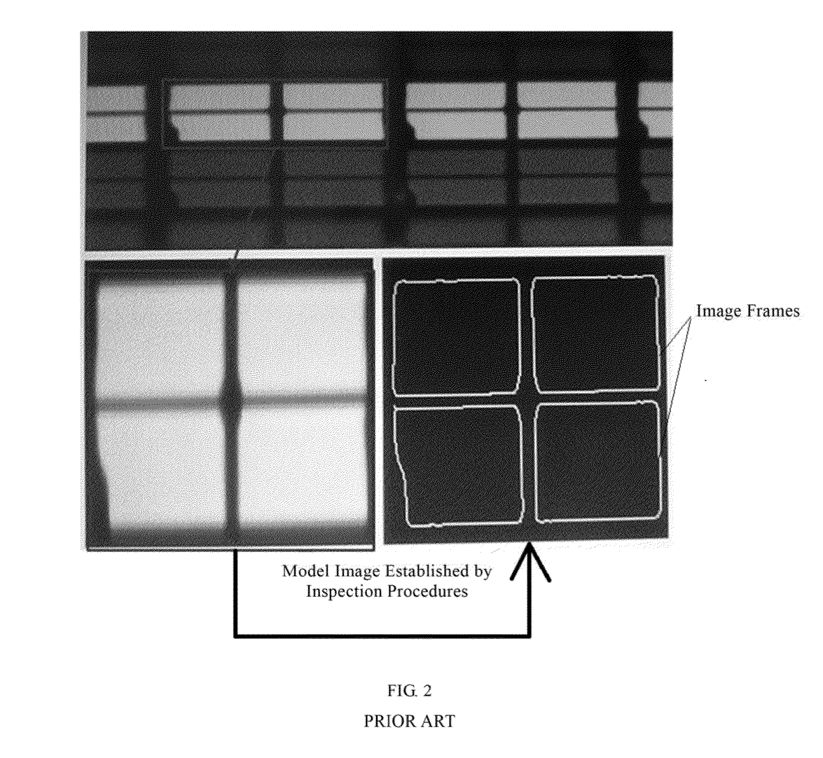

### DETAILED DESCRIPTION

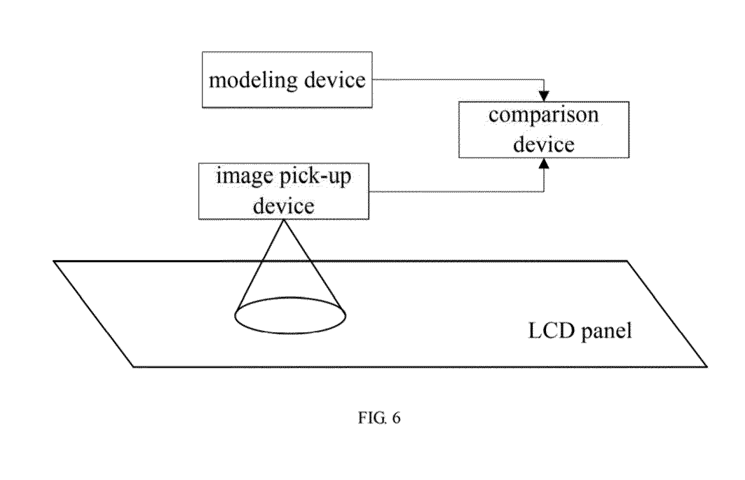

As shown in FIG. 5, the present disclosure discloses an optical detection method of a photo-alignment liquid crystal display (LCD) panel. The method comprises steps:

A. generating a model image according to an internal image of a qualified prearranged detection unit of a photo-alignment LCD panel; and

B. generating an image by obtaining an internal image of the detection unit of the photo-alignment LCD panel to be inspected using a unit of the prearranged detection unit, comparing the image with the model image and generating a comparison result according to the comparison.

In the present disclosure, the prearranged detection unit is used as a reference comparison unit. The internal image of the detection unit is added into the model image. Compared with a method of simply using a sub-pixel frame image as the model image, there are more comparison features and wider coverage using the present method. In this way, more reference details are obtained in comparison, thus effectively reducing image comparison misjudgments and increasing success of interception and inspection.

The present disclosure is further described in detail in accordance with the figures and the preferable examples.

### EXAMPLE 1

The example discloses an optical detection method of a photo-alignment LCD panel. The method comprises steps:

A. using one sub-pixel as a detection unit, and using an internal image of the sub-pixel as a model image; and

B. generating an image by obtaining the internal image of the detection unit of the photo-alignment LCD panel to be inspected using a unit of a prearranged detection unit, comparing the image with the model image and generating a comparison result according to the comparison.

To obtain more reference features and increase comparison accuracy, in the step A, clarity of an internal structure of the detection unit is maximized by regulating multiplying power of an image pick-up device and brightness of a backlight source. Then, the internal image of the qualified detection unit of the photo-alignment LCD panel is obtained as the model image.

In the step B, the internal image of the detection unit to be inspected is compared with the model image using a blurred comparison method of a computer, where a comparison result is generated according to the blurred comparison method.

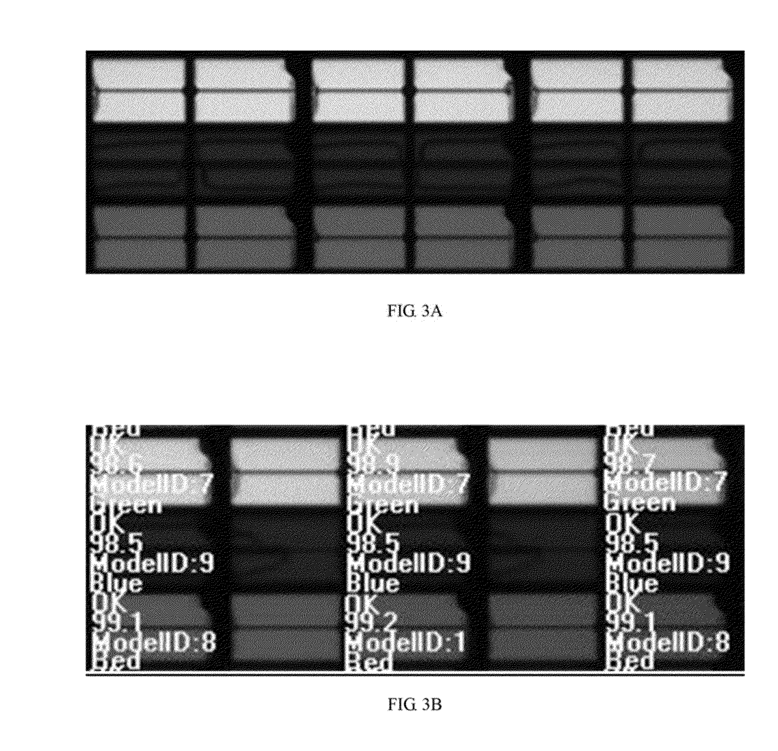

In both the step A and the step B, the model image and the image to be inspected may be pictures photographed directly by the image pick-up device. Or, line features of the internal image are extracted by the computer to form a new picture, the model image and the image to be inspected are formed. In FIG. 3, the inventor finds after study that when abnormal alignment occurs, decorative patterns of dark lines and dark lines resembling patterns of a stomach of a fish may occur in the sub-pixels. The difference from normal sub-pixels is clear. Moreover, poor patterns have obvious line features. Thus, the line patterns of the internal image of the sub-pixels are used as the model image. Only the line patterns are compared (similar to fingerprint identification) without feature comparison related to colors. Difficulty of the comparison can be simplified and speed of the comparison can be increased while ensuring a success of intercepting and inspecting abnormal alignment.

The example is a first division mode of the detection unit. The sub-pixels as a basic member of the pixel are compared one by one, thus increasing the success of intercepting and inspecting a single poor sub-pixel, ensuring integrity of each sub-pixel of a qualified finished product and improving display quality.

### EXAMPLE 2

The example is a further improvement of a first example. To obtain an internal image of a sub-pixel, a sub-pixel frame image is added, thus increasing comparison features and obtaining accurate judgment.

### EXAMPLE 3

Furthermore, in the step A, a detection unit comprises at least three sub-pixels corresponding to primary colors. A model image comprises frame images of all the sub-pixels.

The example discloses an optical detection method of a photo-alignment LCD panel. The method comprises steps:

A. using at least three sub-pixels corresponding to primary colors as the detection unit, and using frame images of all the sub-pixels as the model image; and

B. generating an image by obtaining an internal image of the detection unit of the photo-alignment LCD panel to be inspected using a unit of a prearranged detection unit, comparing the image with the model image and generating a comparison result according to the comparison.

To obtain more reference features and increase comparison accuracy, in the step A, clarity of an internal structure of the detection unit is maximized by regulating multiplying power of an image pick-up device and brightness of a backlight source. Then, the internal image of the qualified detection unit of the photo-alignment LCD panel is obtained as the model image.

In the step B, the internal image of the detection unit to be inspected is compared with the model image by a blurred comparison method of a computer, and a comparison result is generated according to the blurred comparison method.

In both the step A and the step B, the model image and the image to be inspected may be pictures photographed directly by the image pick-up device. Or, line features of the internal image are extracted by the computer to form a new picture, and the model image and the image to be inspected are formed. The line features are used as comparison objects. Only the line patterns are compared (similar to fingerprint identification) without feature comparison related to colors. The comparison difficulty can be simplified and the comparison speed can be increased while ensuring a success of intercepting and inspecting abnormal alignment.

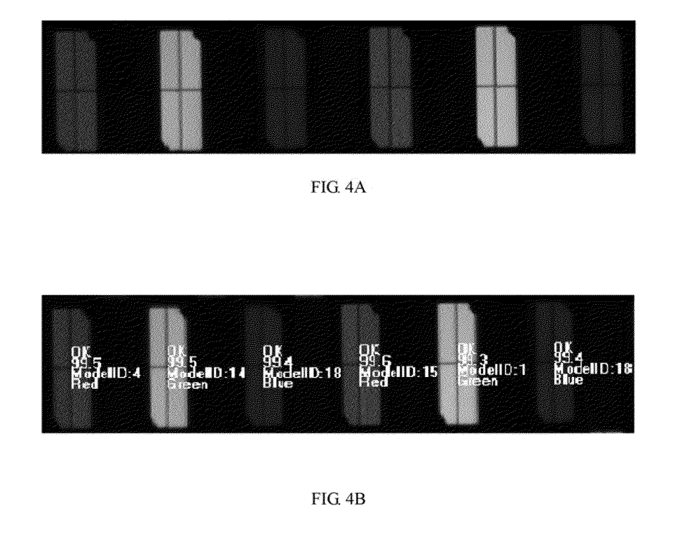

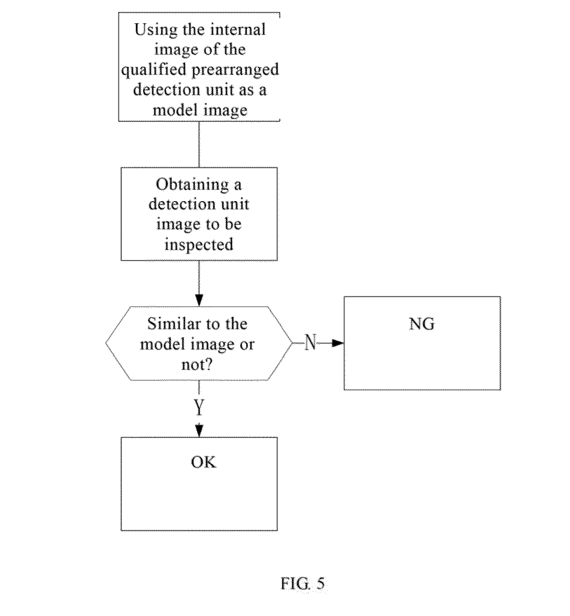

The example is a second division mode of the detection unit. At least three sub-pixels corresponding to primary colors are used as the detection unit, namely that one detection unit at least comprises a complete pixel. LCD uses the pixel as a basic display unit. Each pixel comprises at least three sub-pixels. In practical production, a fault that a certain sub-pixel is not displayed at all may occur. As shown in FIG. 4, the fault may not be identified by the typical detection mode of using one sub-pixel as the detection unit. Thus, in the technical scheme, at least one pixel as the unit acts as one detection unit for detecting the fault of no display of a single sub-pixel in pixel and further increasing the success of interception and inspection.

### EXAMPLE 4

The example is a further improvement of a third example. To obtain a frame image of each sub-pixel in a detection unit, at least one sub-pixel internal image is added. As the features of the sub-pixel internal image are more, the internal image is added and compared for improving judgment accuracy.

### EXAMPLE 5

The present disclosure also discloses an optical detection device of a photo-alignment LCD panel, comprising:

an image pick-up device obtaining an internal image Of a detection unit;

a modeling device coupling with the image pick-up device and obtaining, the internal image of a qualified detection unit of the photo-alignment LCD panel as a model image; and

a comparison device comparing the internal image of the detection unit to be inspected with the model image.

The detection unit is one sub-pixel or a combination of a plurality of sub-pixels.

By using a single sub-pixel as the detection unit, the modeling device can obtain the internal image of the sub-pixel as the model image or add a frame image as the model image. The sub-pixels as a basic member of the pixel are compared one by one, thus increasing a success of intercepting and inspecting a single poor sub-pixel, ensuring integrity of each sub-pixel of a qualified finished product and improving display quality.

By using a plurality of sub-pixels as the detection unit (preferably comprising a complete pixel), the modeling device can obtain the frame image of each sub-pixel as the model image or add the internal image of one or a plurality of sub-pixels as the model image. LCD uses the pixel as a basic display unit. Each pixel comprises at least three sub-pixels. In practical production, a fault that a certain sub-pixel is not displayed at all may occur. Thus, in the technical scheme, at least one pixel as a unit is used as the detection unit, which can detect a no-display fault of a single sub-pixel in pixel. Thus increasing the success of interception and inspection.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. An optical detection method of a liquid crystal display (LCD) panel by photo-alignment, comprising steps of:
A. prearranging a detection unit of a qualified photo-alignment LCD panel, and forming a model image according to a new picture formed by a computer that extracts line features of an internal image of the detection unit; wherein the internal image of the detection unit is obtained by an image pick-up device; the detection unit is one sub-pixel; the model image comprises the internal image of the sub-pixel and at least one sub-pixel frame image; and
B. generating an image by obtaining an internal image of the detection unit of the photo-alignment LCD panel to be inspected using a unit of the prearranged detection unit; comparing the image with the model image using a blurred comparison method of a computer and generating a comparison result according to the comparison.

2. An optical detection method of a liquid crystal display (LCD) panel by photo-alignment, comprising steps:
A. generating a model image according to an internal image of a prearranged qualified detection unit of a photo-alignment LCD panel; and
B. generating an image by obtaining an internal image of the detection unit of the photo-alignment LCD panel to be inspected using a unit of the prearranged detection unit; comparing the image with the model image and generating a comparison result according to the comparison.

3. The optical detection method of the liquid crystal display (LCD) panel by photo-alignment of claim 2, wherein in the step A, the detection unit is one sub-pixel; the model image comprises the internal image of the sub-pixel.

4. The optical detection method of the liquid crystal display (LCD) panel by photo-alignment of claim 3, wherein the model image comprises at least one sub-pixel frame image.

5. The optical detection method of the liquid crystal display (LCD) panel by photo-alignment of claim 2, wherein in the step A, the detection unit comprises at least three sub-pixels corresponding to primary colors; the model image comprises the frame images of all the sub-pixels.

6. The optical detection method of the liquid crystal display (LCD) panel by photo-alignment of claim 5, wherein the model image comprises at least one sub-pixel internal image.

7. The optical detection method of the liquid crystal display (LCD) panel by photo-alignment of claim 2, wherein in the step B, the internal image of the detection unit to be inspected is compared with the model image using a blurred comparison method of a computer, and generating a comparison result according to the comparison.

8. The optical detection method of the liquid crystal display (LCD) panel by photo-alignment of claim 2, wherein in the step A, the qualified internal image of the detection unit of the photo-alignment LCD panel is obtained firstly by an image pick-up device; after that, line features of the internal image are extracted by a computer to form a new picture and the model image is formed.

9. An optical detection device of a photo-alignment liquid crystal display (LCD) panel, comprising:
an image pick-up device obtaining an internal image of a detection unit;
a modeling device coupling with the image pick-up device and recording a model image generated by the internal image of a qualified detection unit of the photo-alignment LCD panel; and
a comparison device comparing an internal image of the detection unit to be inspected with the model image.

10. The optical detection device of the photo-alignment liquid crystal display (LCD) panel of claim 9, wherein the detection unit is one sub-pixel; the modeling device obtains the internal image of the sub-pixel as the model image.

11. The optical detection device of the photo-alignment liquid crystal display (LCD) panel of claim 9, wherein the detection unit comprises at least three sub-pixels corresponding to primary colors; the modeling device obtains the frame images of all the sub-pixels as the model image.
